(19) United States
(12) Patent Application Publication
(10) Pub. No.: US 2017/0276320 A1
(43) Pub. Date: Sep. 28, 2017

(54) LED SPOTLIGHT

(71) Applicant: LEEDARSON LIGHTING CO.,LTD, Zhangzhou, Fujian (CN)

(72) Inventors: Yaling Zhou, Xiamen (CN); Yunwei Chen, Xiamen (CN); Xiaoming Yang, Xiamen (CN)

(21) Appl. No.: 15/508,487

(22) PCT Filed: Jul. 28, 2016
(86) PCT No.: PCT/CN2016/091999

§ 371 Date: Mar. 2, 2017

(30) Foreign Application Priority Data
Sep. 28, 2015 (CN) 201510624896.5

(51) Int. Cl. F21V 5/04; F21V 7/04; F21V 19/00; F21S 8/00

(52) U.S. Cl. CPC F21V 5/04; F21S 8/003; F21V 7/041; F21V 19/003; F21Y 2115/10

(57) ABSTRACT

An LED spotlight includes a lens, a LED light source board and a star shaped or multiple star shaped lighting lined LED light source. The side of the lens is formed as reflective surface. The incident surface is the groove structure of toward away from the sunken of the LED light source. The incident surface includes the first incident portion, the second portion and the transition section between the first incident portion and the second portion. The LED spotlight through setting the incident surface, the exit surface and the reflective surface to become the light allocation structure. The function the light passes through the first incident portion, the second incident portion and the transition section may realize the range between twenty-five degrees and one hundred and twenty in negative degrees adjust. Therefore, the LED spotlight owns the advantage to realize the high efficiency orient light allocation.

### TECHNICAL FIELD

The present invention is related to an LED lighting device and more particularly related to an LED spotlight.

### BACKGROUND

An LED light source owns the advantages of a high lighting efficiency, low radiation, low-battery usage and long lifetime. Therefore, the LED light is used more and more widely. The LED light replaces the traditional lighting devices like an incandescent lamp and a halogen lamp. Using the LED source to gather and floodlight lighting may generally use a reflective cup and a lens to allocate the light. The traditional reflective cup or the lens only use a simple cone shaped reflective surface. Although a simple cone shaped reflective surface may realize the ability of gathering the light, there sill exist the defect in the shape of the light allocation. The structure of the cone shaped reflective surface is difficult to realize the high efficiency of orient light allocation.

### SUMMARY OF INVENTION

In view of this, it is necessary to provide an LED spotlight with a high efficiency of orient light allocation.

An LED spotlight includes a lens, a LED light source board and a star shaped or multiple star shaped lighting lined LED light source. The lens is set on the LED light source board. The lens is the invert structure with the bigger top and the smaller bottom. The bottom of the lens sets the incident surface directly face to the LED light source. The top of the lens parallels the exit surface of the LED light source board. The side of the lens is formed as reflective surface. The incident surface is the groove structure of toward away from the sunken of the LED light source. The incident surface includes the first incident portion, the second portion and the transition section between the first incident portion and the second portion. The first incident portion is set in the middle of the incident surface and directly face to the light source parallels the direction of the axis from the LED light source. The first incident portion is set parallel to the LED light source board to make the light from the LED light source toward the exit surface. The second incident portion is set outside the first incident portion. The transition section is curve structure. The transition section uses the light near the axis direction sent out from the LED light source to refract to the reflective surface. The second incident portion is vertical the LED light source board to make the light away from the central axis from the LED light source refract to the reflective surface. The reflective surface uses the coming light to reflect toward the exit surface.

Comparing with the existed technology, the LED spotlight through setting the incident surface, the exit surface and the reflective surface to become the light allocation structure. One portion of the LED light source passes through the incident surface and directly irradiates out toward the exit surface. The other portion of the light passes through the incident surface and passes by the reflection from the reflection surface and finally irradiates toward the exit surface. The incident surface includes the first incident portion, the second incident portion and the transition section. The first incident portion is set in the middle of the incident surface and parallel to the LED light source board. Matching of the LED light source makes the light parallel to the middle axis of the lens. The second incident portion is set outside the first incident portion and be vertical to the LED light source board and refract the light from the LED light source toward the reflective surface, and then irradiate the light toward the lighting surface through the reflective surface. The transition section connects the first incident portion and the second incident portion and be the curve structure. The curve structure is used to refract the light toward the reflective surface, and then irradiate the light toward the light surface through the reflective surface. Therefore, the function the light passes through the first incident portion, the second incident portion and the transition section may realize the range between twenty-five degrees and one hundred and twenty in negative degrees adjust. Meanwhile, most of the light passes through may also passes through the second incident portion and the transition section's refraction to make the light irradiate toward the reflective surface, and then irradiate outside through the reflection of the reflective surface. Therefore, the LED spotlight owns the advantage to realize the high efficiency orient light allocation.

### BRIEF DESCRIPTION OF DRAWINGS

FIG. 1 is the first embodiment illustrated drawing for the present invention, an LED spotlight.

FIG. 2 is the main drawing from FIG. 1 that illustrates the lens of the LED spotlight.

FIG. 3 is the section drawing along FIG. 2 that illustrates the A-A line.

### DETAILED DESCRIPTION

The embodiment and the attached drawing are to describe the present invention detailed in following statement.

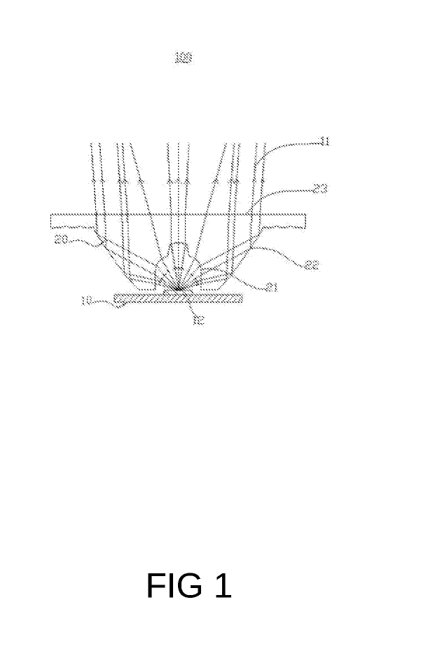

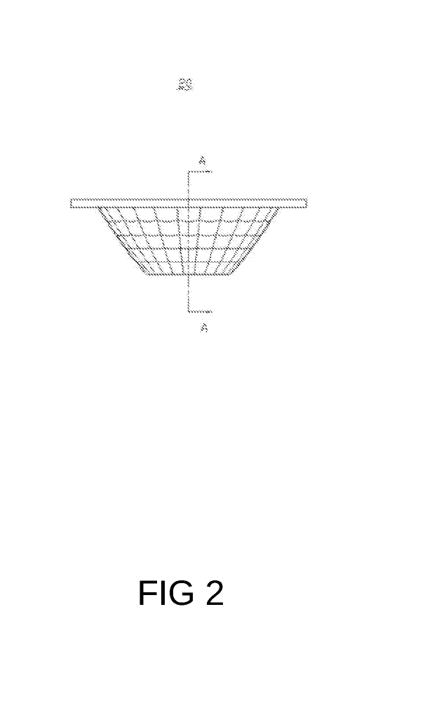

Please refer to FIG. 1 to FIG. 3, the first embodiment for the present invention, the LED spotlight (100).

Please refer to the FIG. 1 to FIG. 3, an LED spotlight (100) includes a lens (20), an LED light source board (10), and a star shaped or multiple star shaped lighting lined LED light source (12). The lens (20) is the invert structure with the bigger top and the smaller bottom. The bottom of the lens (20) sets the incident surface (21) directly face to the LED light source (12). The top of the lens (20) parallels exit surface (23) of the LED light source board (10). The side of the lens is formed as reflective surface. The incident surface is the groove structure of toward away from the sunken of the LED light source. Among them, the reflective surface (22) is the cone shaped of curve structure. The incident surface (21) is the rotary structure created by the rotated based on the LED light source (12) central axis line.

Through the above structure of the LED spotlight (100) passes through the incident surface (21), the exit surface (23), and the reflective surface (22) to become the structure of light allocation. One portion of the light from the LED light source (12) passes through the incident surface (21) and directly irradiate out toward the exit surface (23). The other portion of the light passes through the incident surface (21) and irradiates out toward the exit surface (23) through the reflective surface (22). The incident surface (21) is the groove structure of away from the sunken of the LED light source (12). Imitating the shape of the halogen lamp is to satisfy the diversify need in the market. The incident surface (21) is the rotary structure rotated by the central axis line to make most of the light (11) may enter through the reflective surface (22) and own the evenly light allocation around. The reflective surface (22) is the cone curved structure to make most of the light (11) may reflect and irradiate through the reflective surface (22).

The lens (20) is set near the LED light source board (10). The incident surface (21) is set covered on the LED light source. The lens's (20) bottom is set closely to the LED light source board (10) to make the heat produced by the LED light source (12) passes through the LED light source board (10) to the lens (20). Meanwhile, the incident surface (21) is set covered on the LED light source (12). The lens (20) is whole set made of the glass, plastic, or the china.

Please refer to FIG. 1 to FIG. 3, the incident surface (21) includes the first incident portion (211), the second portion (212) and the transition section (213) between the first incident portion and the second portion. The first incident portion (211) is set in the middle of the incident surface (21) and directly face to the light source parallels the direction of the axis from the LED light source (12). The first incident portion (211) is set parallel to the LED light source board (10) to make the light (11) from the LED light source (12) toward the exit surface (23). The second incident portion (212) is set outside the first incident portion (211). The transition section (213) is curve structure. The transition section (213) uses the light near the axis direction (212) sent out from the LED light source (12) to refract to the reflective surface. The second incident portion is vertical the LED light source board (10) to make the light (11) away from the central axis from the LED light source (12) refract to the reflective surface (22). The reflective surface (22) uses the coming light (11) to reflect toward the exit surface (23).

From the above structure, the incident surface (21) includes the first incident portion (211), the second incident portion (212) and the transition section (213). The first incident portion (211) is set in the middle of the incident surface (21) and parallel to the LED light source board (10). Matching of the LED light source (12) makes the light (11) parallel to the middle axis of the lens (20). The second incident portion (212) is set outside the first incident portion (211) and be vertical to the LED light source board (10) and refract the light (11) from the LED light source (12) toward the reflective surface (22), and then irradiate the light (11) toward the lighting surface through the reflective surface (22). The transition section (213) connects the first incident portion (211) and the second incident portion (212) and be the curve structure. The curve structure is used to refract the light (11) toward the reflective surface (22), and then irradiate the light (11) toward the light surface through the reflective surface (22). Therefore, the function the light (11) passes through the first incident portion (211), the second incident portion (212) and the transition section (213) may realize the range between twenty-five degrees and one hundred and twenty in negative degrees adjust. The first incident surface (211) is the spherical surface with high curve rate or be paralleled to the LED light source board (10); therefore, the first incident portion may gather the light (11) toward the middle axis line of the lens (20) to make the light (11) owns the light irradiation in small angle. Passing through the second incident portion (212) mostly set vertical to the LED light source board (10) to make the incident surface (21) be high. Most of the light (11) may pass through the second incident portion (212) and the transition section's (213) refraction to irradiate the light (11) toward the reflective surface (22), and then irradiate out through the reflection of the reflective surface (22). On one hand, increase most of the optical efficiency and down the lighting spot to make the better lighting. On the other hand, most of the light (11) realize the light gathering or the big angle irradiation through the light allocation to realize the adjust of the light bunch angle.

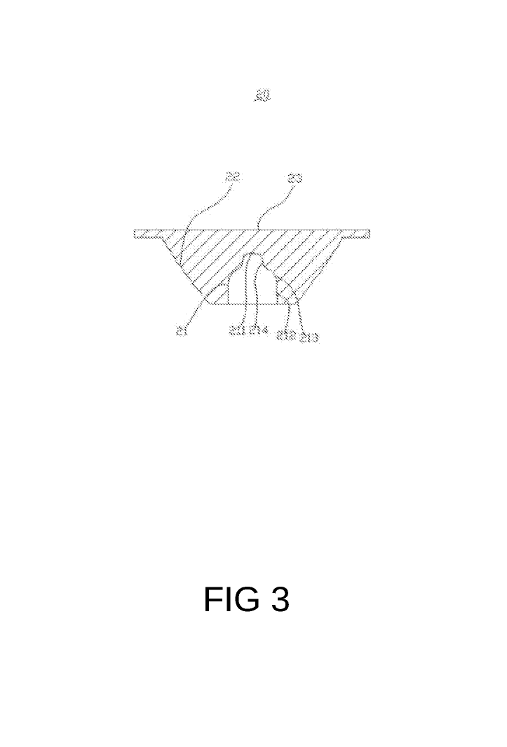

Please refer to FIG. 3, include the stage (214). One end of the stage (214) is related to the first incident portion (211). The other end of the stage (214) is related to the transition section (213). The set of the stage (214) make the height of the first incident portion (211) relative to the light source board (10) is higher than the transition (213) and the second incident portion (212) relative to the light source board. The stage (214) is vertically set on the LED light source board (10).

In conclusion, the first incident surface (211) is the spherical surface with high curve rate or be paralleled to the LED light source board (10); therefore, the first incident portion may gather the light (11) toward the middle axis line of the lens (20) to make the light (11) owns the light irradiation in small angle. Passing through the second incident portion (212) mostly set vertical to the LED light source board (10) to make the incident surface (21) be high. Most of the light (11) may pass through the second incident portion (212) and the transition section's (213) refraction to irradiate the light (11) toward the reflective surface (22), and then irradiate out through the reflection of the reflective surface (22). On one hand, increase most of the optical efficiency and down the lighting spot to make the better lighting. On the other hand, most of the light (11) realize the light gathering or the big angle irradiation through the light allocation to realize the adjust of the light bunch angle. Realize the range between twenty-five degrees and one hundred and twenty in negative degrees adjust. The whole height of the lens (20) may be done lower. The set of the stage (214) may make portion of the light away from the central axis line irradiated from the LED light source (12) on the stage (214) toward the exit surface (23). Comparing with the situation of not setting the stage (214), the light after refracting is nearer the direction of the central axis line. Therefore, setting the stage is good for gather the light by irradiating the light in paralleling on central axis line.

The statement above just for the better embodiment, not for limiting the present invention. All the modification, equal to any change and improvement that are based on the present invention's spirit and principle, may be protected in the present invention protection range.

1. An LED spotlight comprising a lens, a LED light source board and a star shaped or multiple star shaped lighting lined LED light source, wherein the lens is set on the LED light source board, the lens is the invert structure with the bigger top and the smaller bottom, characterized in that: the bottom of the lens sets the incident surface directly face to the LED light source; the top of the lens parallels the exit surface of the LED light source board; the side of the lens is formed as reflective surface; the incident surface is the groove structure of toward away from the sunken of the LED light source; the incident surface comprises the first incident portion, the second portion and the transition section between the first incident portion and the second portion; the first incident portion is set in the middle of the incident surface and directly face to the light source parallels the direction of the axis from the LED light source; the first incident portion is set parallel to the LED light source board to make the light from the LED light source toward the exit surface; the second incident portion is set outside the first incident portion; the transition section is curve structure; the transition section uses the light near the axis direction sent out from the LED light source to refract to the reflective surface; the second incident portion is vertical the LED light source board to make the light away from the central axis from the LED light source refract to the reflective surface; the reflective surface uses the coming light to reflect toward the exit surface.

2. The LED spotlight of claim 1, characterized in that: the lens whole set is made of the glass, plastic, or the china.

3. The LED spotlight of claim 1, characterized in that: comprising the stage; wherein one end of the stage is related to the first incident portion; the other end of the stage is related to the transition section; the set of the stage make the height of the first incident portion relative to the light source board is higher than the transition and the second incident portion relative to the light source board.

4. The LED spotlight of claim 3, characterized in that: the stage is vertically set on the LED light source board.

5. The LED spotlight of claim 1, characterized in that: the lens is set near the LED light source board; the incident surface is set covered on the LED light source.

6. The LED spotlight of claim 1, characterized in that: the reflective surface is the cone shaped of curve structure.

7. The LED spotlight of claim 1, characterized in that: the incident surface is the rotary structure rotated by the central axis line.

8. The LED spotlight of claim 1, characterized in that: the bottom of the lens is set closely to the LED light source board to make the heat produced by the LED light source passing through the LED light source board to the lens; meanwhile, the incident surface is set covered on the LED light source.
